(19) United States
(12) Patent Application Publication
(10) Pub. No.: US 2018/0317032 A1
(43) Pub. Date: Nov. 1, 2018

(54) METHOD FOR PRODUCING A SUPPORTING FRAME OF A HEARING AID, SUPPORTING FRAME AND HEARING AID

(71) Applicant: SIVANTOS PTE. LTD., SINGAPORE (SG)

(72) Inventors: JOHANNES KUHN, NUERNBERG (DE); OLIVER NIPP, ECKENTAL (DE)

(21) Appl. No.: 15/964,515

(22) Filed: Apr. 27, 2018

(30) Foreign Application Priority Data
Apr. 27, 2017 (DE) 10 2017 207 143.5

(51) Int. Cl. H04R 25/00; H04R 25/02

(52) U.S. Cl. CPC H04R 25/658; H01Q 1/38; H04R 25/652; H04R 25/02

(57) ABSTRACT

A method for producing a supporting frame includes providing two frame halves for receiving and holding electrical and electronic assemblies of a hearing aid including a transmitting and/or receiving unit for electromagnetic waves. An antenna element is integrated into at least one of the frame halves. The supporting frame is produced in a two-component injection-molding process with a first plastic material which is suitable for laser direct structuring and with an electrically non-conductive second plastic material which has an increased degree of mechanical stability in comparison to the first plastic material. A supporting frame of a hearing aid and a hearing aid having a supporting frame are also provided.

### CROSS-REFERENCE TO RELATED APPLICATION

This application claims the priority, under 35 U.S.C. § 119, of German Patent Application DE 10 2017 207 143.5, filed Apr. 27, 2017; the prior application is herewith incorporated by reference in its entirety.

### BACKGROUND OF THE INVENTION

### Field of the Invention

The invention relates to a method for producing an (electronic) supporting frame of a hearing aid for receiving and holding electrical and electronic assemblies. The invention further relates to a supporting frame which is produced according to such a method and also to a hearing aid which is provided with such a supporting frame.

Hearing aids are portable hearing devices that are used for treating the hard of hearing or hearing-impaired. In order to meet numerous individual needs, different constructions of hearing aids are provided, such as behind-the-ear hearing devices (BTE) and hearing devices with an external receiver (RIC: receiver in the canal) as well as in-the-ear hearing devices (ITE), for example including concha hearing devices or canal hearing devices (ITE: in-the-ear, CIC: completely-in-channel, IIC: invisible-in-the-channel). The hearing devices listed by way of example are worn on the outer ear or in the auditory canal of a hearing aid user. Furthermore, bone conduction hearing aids, implantable or vibrotactile hearing aids are, however, also available on the market. They involve the damaged hearing being stimulated either mechanically or electrically.

Hearing aids of that kind basically have the important (hearing device) components of an input transducer, an amplifier and an output transducer. The input transducer is generally an acoustoelectric transducer, such as a microphone for example. The output transducer is usually realized as an electroacoustic transducer, for example as a miniature loudspeaker (receiver) or as an electromechanical transducer, such as a bone conduction receiver for example. The amplifier is usually integrated into a signal-processing device. The power is usually supplied by a battery or a rechargeable storage battery.

Hearing devices of that kind also have, for example, an electromagnetic receiver, for example an antenna element in the form of an RF antenna, through the use of which the hearing device can be coupled, for example, to an operator control element (remote operator control) and/or to a further hearing device in such a way that signals can be transmitted. For reasons of space, the same antenna element is generally used for transmitting and receiving data.

Hearing devices are preferably constructed in a particularly space-saving and compact manner, so that they can be worn by a hearing device user in as inconspicuous a manner as possible. As a result, increasingly small hearing devices which are being produced have an increasingly high degree of wearer comfort, and therefore can hardly be felt by a user when worn on or in an ear. However, due to the resulting reduced installation space, it is becoming increasingly difficult to accommodate and/or to install conventional antenna elements for wireless signal transmission in hearing devices of that kind.

Hearing devices having supporting frames (electronic frame, frame) including two frame halves, which can be put together, for holding and receiving the electrical or electronic assemblies or components within a (device) housing are conceivable. Supporting frames or frame halves of that kind are constructed, for example, as injection-molded MID components (MID: Molded Interconnected Devices). A frame half of that kind in the form of a circuit carrier can be produced, for example, from a laser-direct-structurable plastic material, so that the antenna element can be integrated into the supporting frame itself, in particular by using laser direct structuring (LDS), as an electrically conductive structure. Due to the integration of the antenna element into the supporting frame, an antenna length which is required for an effective transmission/reception characteristic of the antenna element is possible even in the case of hearing aids with a reduced installation space.

The frame halves of the supporting frame are therefore substantially each in the form of an injection-molded circuit carrier in which an electrical conductor track or microstrip line is incorporated as an antenna element or antenna structure. In that case, a thermoplastic is doped with a (non-conductive) laser-activatable metal compound as a plastic additive for the purpose of producing the supporting frame or the frame halves of the supporting frame. The frame half or each frame half is produced from that plastic material by using a single-component injection-molding process in that case. The future conductor track or microstrip line of the antenna element is then written onto the plastic of the frame half using a laser beam, wherein the plastic additive is activated. The activated regions are then locally provided with an electrically conductive metallization as a microstrip line or conductor track.

LDS-compatible plastic materials of that kind disadvantageously have comparatively poor mechanical properties. In particular, the mechanical stability is disadvantageously influenced in the event of a reduction in the physical size of components which are produced in that way. That is judged to be critical particularly in the field of component points which are subjected to mechanical stress, such as for mutually fastening the frame halves to one another for example. As a result, it is necessary, for example, that a certain minimum physical size of the supporting frame is not undershot, so that a further reduction in the size of hearing devices is disadvantageously hampered, or a non-laser-direct-structurable plastic material with better mechanical stability has to be avoided.

### SUMMARY OF THE INVENTION

It is accordingly an object of the invention to provide a method for producing a supporting frame of a hearing aid, a supporting frame and a hearing aid, which overcome the hereinafore-mentioned disadvantages of the heretofore-known methods, supporting frames and hearing aids of this general type and in which the supporting frame is suitable for LDS and at the same time has as high a degree of mechanical stability as possible.

With the foregoing and other objects in view there is provided, in accordance with the invention, a method for producing a supporting frame, which comprises providing two frame halves for receiving and holding electrical and electronic assemblies of a hearing aid including a transmitting and/or receiving unit for electromagnetic waves, integrating an antenna element into at least one of the frame halves, and producing the supporting frame in a two-component injection-molding process with a first plastic material which is suitable for laser direct structuring, and with an electrically non-conductive second plastic material which has an increased degree of mechanical stability in comparison to the first plastic material.

The method according to the invention is suitable and constructed for the purpose of producing a supporting frame of a hearing aid. The supporting frame is expediently formed from two frame halves which can be put together and which are provided and constructed for receiving electrical and electronic assemblies of the hearing aid and for holding or for fixing the electrical and electronic assemblies against one another in one position. In this case, the assemblies are preferably components of the hearing aid.

In this case, the assemblies include a transmitting and/or receiving unit for electromagnetic waves. In the text which follows, electromagnetic waves are intended to be understood to mean, in particular, radio signals, also called RF signals. The transmitting and/or receiving unit has an associated antenna element for transmitting and/or receiving the RF signals, which antenna element is integrated at least into one of the frame halves. In other words, the antenna element is an integral component of the frame half or each frame half. This means that the antenna element substantially cannot be detached from the respective frame half, and the outer contour of the respective frame half does not substantially protrude.

According to the method, it is provided in this case that the supporting frame is produced in a two-component injection-molding process (2C process) with a first plastic material, which is suitable for laser direct structuring (LDS), and with an electrically non-conductive second plastic material which has an increased degree of mechanical stability in comparison to the first plastic material. A particularly suitable method for producing the supporting frame is realized as a result.

In contrast to the prior art, the supporting frame is therefore produced as a two-component injection-molded part, wherein the mechanical stability of the supporting frame is advantageously improved by the mechanically more stable second plastic material. As a result, it is possible to reduce the physical size of the supporting frame and therefore the physical size of a hearing aid which is provided with the supporting frame, without disadvantageously influencing the mechanical stability of the supporting frame.

In a suitable development, the second plastic material is used to produce a mechanically stable frame scaffold of the frame half or each frame half, the first plastic material being applied to the frame scaffold for the purpose of forming a laser-direct-structurable surface. A particularly high degree of mechanical stability of the respective frame half, in particular in the region of connection or fastening points for mutually fastening the frame halves, is ensured by the frame scaffold.

In an advantageous embodiment of the method, the antenna element is produced by using laser direct structuring of the first plastic material of the respective frame half, in particular the surface, or integrated into the respective frame half/surface. Particularly expedient and cost-effective functional integration of the antenna element into the supporting frame is realized in this way.

In an expedient construction, the first plastic material has a higher dielectric (relative) permittivity than the second plastic material. This is consequently advantageously conveyed to the antenna power and/or the antenna length of the antenna element. In this case, the increased permittivity has, in particular, an advantageous effect on a reduction in the required antenna length.

With the objects of the invention in view, there is also provided a supporting frame of a hearing aid, in which the supporting frame is produced according to a method of this kind. A mechanically stable supporting frame which is suitable and constructed for LDS at the same time is realized in this way.

In a preferred application, the supporting frame according to the invention is part of a hearing aid. In this case, the supporting frame is preferably inserted in a housing, so that the antenna element and also the assemblies are protected against external influences.

With the objects of the invention in view, there is concomitantly provided a hearing aid comprising a housing including a supporting frame which is inserted in the housing according to the invention for receiving and holding electrical or electronic assemblies which include a transmitting and/or receiving unit for electromagnetic waves, and an associated antenna element which is in the form of an integral constituent part of the supporting frame.

Other features which are considered as characteristic for the invention are set forth in the appended claims.

Although the invention is illustrated and described herein as embodied in a method for producing a supporting frame of a hearing aid, a supporting frame and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified, diagrammatic, longitudinal-sectional view of a hearing aid including a supporting frame which is accommodated in a housing;

FIG. 2 is a perspective view of a frame half of a specific embodiment of the supporting frame looking at an outer side;

FIG. 3 is a perspective view of an alternative embodiment of the frame half;

FIG. 4 is a perspective view of a frame half looking at an inner side; and

FIG. 5 is a perspective view of an alternative embodiment of the frame half.

### DETAILED DESCRIPTION OF THE INVENTION

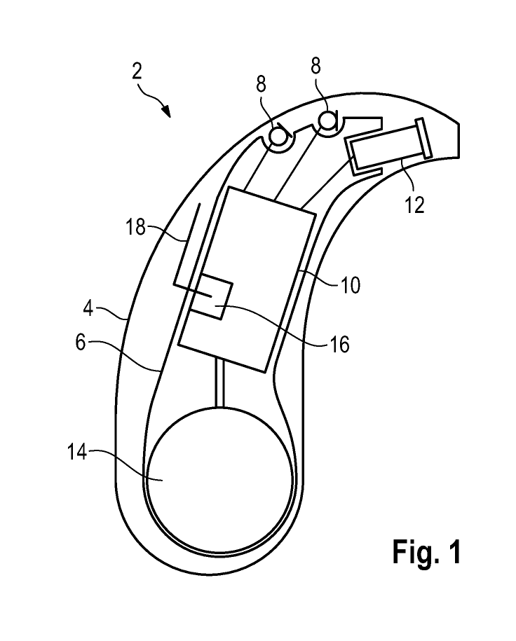

Referring now in detail to the figures of the drawings, in which parts and variables which correspond to one another are always provided with the same reference symbols throughout, and first, particularly, to FIG. 1 thereof, there are seen only important elements and components of a hearing aid 2, without reproducing the position, connections or shape thereof realistically.

The hearing aid 2 illustrated in FIG. 1 is a hearing aid 2 to be worn behind the ear. However, the invention is also conceivable for in-the-ear hearing aids, wherein a correspondingly different configuration of the illustrated components is provided in that case.

The hearing aid 2 has a shell-like (device) housing 4 which is composed of plastic and into which a supporting frame 6 is inserted. The supporting frame 6 is a two-component injection-molded plastic part. The supporting frame 6 generally serves to receive electrical and electronic assemblies of the hearing aid 2 and also to fix and hold these assemblies within the housing 4 in specific positions relative to one another. Specifically, one or more microphones 8 for receiving ambient sound (that is to say an acoustic signal) are disposed in the supporting frame 6. To this end, for example, a printed circuit carrier (printed circuit board, for short: PCB) which supports at least some of the electrical or electronic components is folded into the supporting frame 6.

The microphones 8 are acoustoelectric transducers for converting the acoustic sound into electrical audio signals. A signal-processing device 10, which is likewise integrated into the housing 4, is provided for processing these audio signals. An output signal of the signal-processing device 10 is transmitted to a loudspeaker or receiver 12 which, as an electroacoustic transducer, outputs an acoustic signal. An output sound is transmitted to an eardrum of the hearing-aid user, possibly through a sound tube which is fixed or can be fixed in an auditory canal of a hearing-aid user with an ear mold.

Power is supplied to the hearing aid 2 and, in particular, to the signal-processing device 10 by a battery 14 which is likewise integrated into the housing 4. The signal-processing device 10, the receiver 12 and the battery 14 are likewise disposed in the supporting frame 6, so that the supporting frame 6, with the components disposed therein, can easily be removed from the housing 4 in order to be able to exchange the housing 4, for example.

The signal-processing device 10 is also configured and constructed to process electromagnetic waves. To this end, the signal-processing device 10 has a transmitting and receiving device (transceiver) 16 for generating and detecting electromagnetic waves and/or for decoding the electromagnetic waves. The transmitting and receiving device 10 is electrically connected to an antenna element 18 in order to transmit and to receive electromagnetic waves.

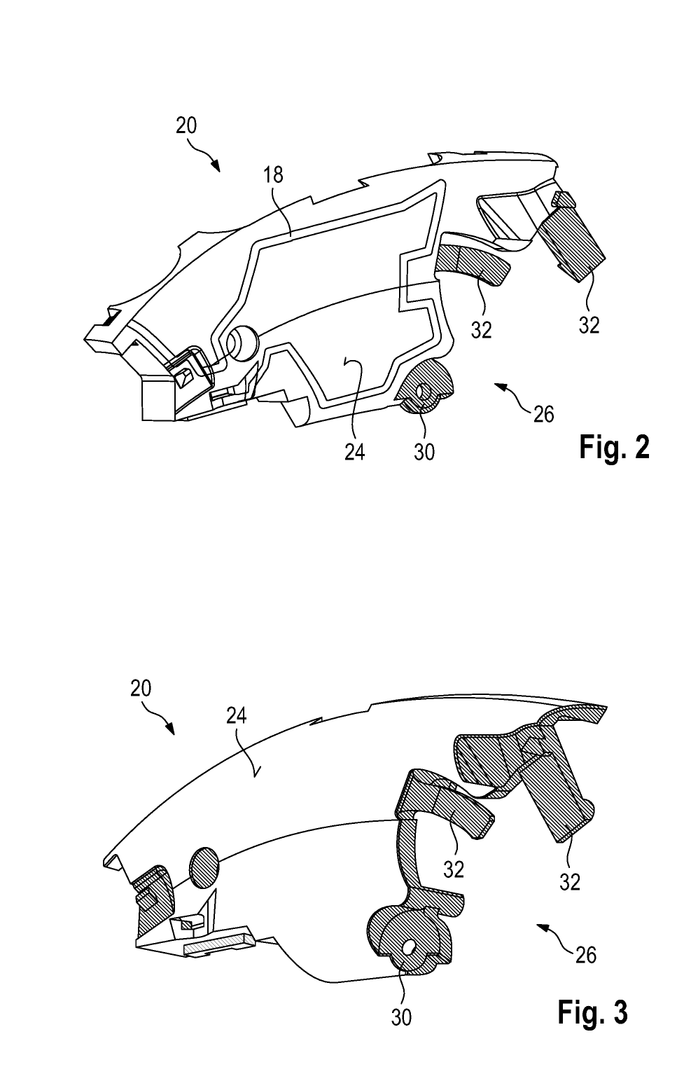

The antenna element 18, which is constructed as an RF antenna, is in the form of an integral constituent part of the supporting frame 6, in particular in the form of a conductive structure which is integrated into the supporting frame 6. In this case, the antenna element 18 is—as shown in FIG. 2 for example—mounted directly on the supporting frame 6. It is therefore not at a distance from the surface and cannot be detached from the supporting frame 6 without being destroyed.

The antenna element 18 is mounted on the supporting frame 6 in particular by using MID technology. Laser direct structuring (LDS for short) is used for this purpose. Microstrip lines or conductor structures which are applied onto the surface of the supporting frame 6 are then optionally electrically insulated and therefore protected against damage by a protective lacquer or coating.

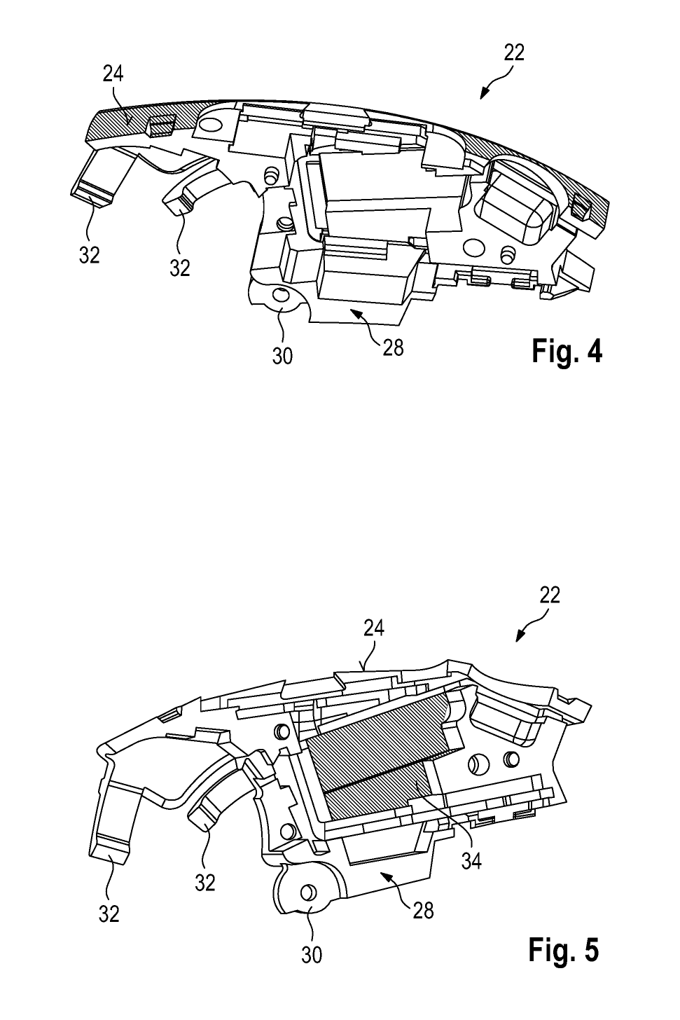

The supporting frame 6 is longitudinally divided into two shell-like frame halves 20 and 22 along a separating plane which is oriented along the longitudinal direction of the hearing aid. In this case, the frame halves 20 (FIGS. 2 and 3) and 22 (FIGS. 4 and 5) are connected by clipping, screwing, adhesive bonding and/or by using holding pins after the insertion of the assemblies accommodated in the frame halves. In the connected (supporting frame) state, the assemblies are therefore held between the frame halves 20 and 22 at least partially in an interlocking manner in recesses which are not depicted in any detail.

FIGS. 2 and 3 show the frame halves 20 in two exemplary embodiments looking at an outer side 24 of the supporting frame 6. The outer side 24 is, in the assembled state, that surface of the frame half 20 which faces the housing 4. In the exemplary embodiment of FIG. 2, the antenna element 18 is disposed on the outer side 24, that is to say on the lateral surface of the supporting frame 6.

The supporting frame 6 or the frame halves 20 and 22 are produced as two-component injection-molded parts from two plastic materials. In this case, a mechanically stable frame scaffold 26 and 28 is manufactured from a mechanically stable plastic material which has, for example, a 5 to 20% content of glass fibers. In this case, the frame scaffold 26, 28 forms the contours of the frame halves 20 and 22, which contours are required for receiving and holding the assemblies and also for mutual fastening.

The frame scaffold 26 or 28 is then, as an insert part, encapsulated at least in sections by the second plastic material by injection molding. In this case, the second plastic material is embodied as an MID plastic which is suitable for LDS.

As is comparatively clearly shown in FIGS. 2 and 3, the frame scaffold 26, 28 substantially forms the inner part of the supporting frame 6 in this case, wherein the surface 24 which is mounted thereon is manufactured from the LDS plastic.

The plastic materials of the supporting frame 6 preferably have a substantially higher permittivity than the plastic material of the housing 4. It has been found that the increased permittivity of the frame material allows critical shortening of the antenna length due to dielectric interaction with the electromagnetic field which is generated and received by the antenna element 18.

FIG. 2 illustrates the frame half 20. The LDS-manufactured antenna element 18 is mounted onto the outer-side surface 24. FIG. 2 shows an eyelet-shaped or ring-shaped fastening face 30 of the frame scaffold 26 of the frame half 20, which fastening face is configured, for example, for pinning with the housing 4 and/or with a battery compartment for holding the battery 14 and/or with the frame half 22. Furthermore, FIG. 2 shows two holder arms 32 of the frame scaffold 26, which holder arms are in the form of latching arms or hooks and ensure an on/off functionality of the battery compartment in the joint or supporting frame state.

FIG. 3 shows an alternative construction of the frame half 20 without the antenna element 18. In FIGS. 2 and 3, the regions of the frame scaffold 26 of the frame half 20, that is to say the parts of the supporting frame 6 which are produced from the mechanically more stable plastic material, are provided with a hatching for improved clarity.

FIGS. 4 and 5 show the inner side of the frame half 22 looking at the frame scaffold 28 in two conceivable embodiments. In these illustrations, the laser-direct-structurable outer side 24 is provided with a hatching, and the frame scaffold 28 is shown without hatching. In these illustrations, the compartments and receptacles for holding the assemblies, which compartments and receptacles are formed by the frame scaffolds 26 and 28, are comparatively more clearly identifiable.

In the exemplary embodiment of FIG. 5, an inner-side surface 34, in addition to the outer side 24, is provided with the LDS plastic material. In this case, the LDS plastic material preferably has a dielectric permittivity which is increased in relation to the plastic material of the frame scaffolds 26 and 28. As an alternative, it is likewise conceivable, for example, that the surface 34, which is illustrated with hatching in FIG. 5, is produced from a third plastic material with a comparatively high permittivity.

The invention is not limited to the above-described exemplary embodiments. Rather, other variants of the invention can also be derived therefrom by a person skilled in the art, without departing from the subject matter of the invention. In particular, all of the individual features described in connection with the exemplary embodiments can furthermore also be combined with one another in different ways, without departing from the subject matter of the invention.

The following is a summary list of reference numerals and the corresponding structure used in the above description of the invention:
2 Hearing aid
4 Housing
6 Supporting frame
8 Microphone
10 Signal-processing device
12 Receiver
14 Battery
16 Transmitting and receiving device
18 Antenna element
20, 22 Frame half
24 Outer side/surface
26,28 Frame scaffold
30 Fastening area
32 Holding arm
34 Surface

1. A method for producing a supporting frame, the method comprising the following steps:
providing two frame halves for receiving and holding electrical and electronic assemblies of a hearing aid including at least one of a transmitting or receiving unit for electromagnetic waves;
integrating an antenna element into at least one of the frame halves; and
producing the supporting frame in a two-component injection-molding process with a first plastic material being suitable for laser direct structuring and with an electrically non-conductive second plastic material having an increased mechanical stability in comparison to the first plastic material.

2. The method according to claim 1, which further comprises using the second plastic material to produce a mechanically stable frame scaffold of at least one of the frame halves, and applying the first plastic material to the frame scaffold for forming a laser-direct-structurable surface.

3. The method according to claim 1, which further comprises producing the antenna element by using laser direct structuring of the first plastic material of a respective one of the frame halves.

4. The method according to claim 1, which further comprises producing the antenna element by using laser direct structuring of a surface of the first plastic material of a respective one of the frame halves.

5. The method according to claim 1, wherein the first plastic material has a higher permittivity than the second plastic material.

6. A supporting frame of a hearing aid, the supporting frame comprising:
two frame halves for receiving and holding electrical and electronic assemblies of the hearing aid including at least one of a transmitting or receiving unit for electromagnetic waves;
an antenna element integrated into at least one of said frame halves; and
first and second plastic materials being suitable for two-component injection molding, said first plastic material being suitable for laser direct structuring and said second plastic material being electrically non-conductive and having an increased mechanical stability in comparison to said first plastic material.

7. A hearing aid, comprising:
a housing,
a supporting frame being inserted in said housing;
said supporting frame including two frame halves for receiving and holding electrical or electronic assemblies including at least one of a transmitting or receiving unit for electromagnetic waves;
said supporting frame including first and second plastic materials being suitable for two-component injection molding, said first plastic material being suitable for laser direct structuring and said second plastic material being electrically non-conductive and having an increased mechanical stability in comparison to said first plastic material; and
an antenna element being an integral constituent part of at least one of said frame halves.
